(19) United States
(12) Patent Application Publication
(10) Pub. No.: US 2002/0096800 A1
(43) Pub. Date: Jul. 25, 2002

(54) Encapsulated fixed window module with continuous seal trim strip for a motor vehicle

(76) Inventors: John D. Keeney, Fremont, NH (US); Nathan W. Ellis, Brentwood, NH (US)

Correspondence Address: DYKEMA GOSSETT PLLC, 39577 WOODWARD AVENUE, SUITE 300, BLOOMFIELD HILLS, MI, 48304-5086, US

(21) Appl. No.: 09/548,852

(22) Filed: Apr. 13, 2000

(51) Int. Cl. B29C 70/76

(52) U.S. Cl. 264/252

(57) ABSTRACT

A window module has a fixed-pane window which is encapsulated by a molded trim piece having an integral portion which extends around an adjacent movable window opening. The integral trim piece is formed of EPDM. The window module is constructed by placing a window pane, a division post and an end of an extruded continuous EPDM trim strip and a header trim strip into a mold into which the EPDM polymer is injected to integrate and encapsulate the inserts.

The present invention relates generally to motor vehicle window module designs and methods of making such modules and, more specifically, relates to the problems associated with the assembly of fixed window modules from discrete trim components.

### BACKGROUND OF THE INVENTION

In a number of motor vehicles, the rear door assembly is designed such that there is a forward window opening that carries a retractable window pane and a rearward opening that is equipped with a fixed window pane. Rear fixed windows of conventional design may be assembled from discrete elements that include the window panel, a rear post that serves as a track for an adjacent movable window and various configurations of moldings or trim pieces, most specifically an extruded header and B-pillar trim piece that may be mechanically attached to the window module assembly using an interlocking channel or the like. The trim in some prior art designs comprises an article in the nature of a pre-formed resilient band. In those designs, the window is inserted into a channel of the trim band which resiliently engages the window pane, but often less than securely. Conventional designs suffer from a number of deficiencies due to their assembly from discrete components such as water leakage, wind noise and problems generally with fit and finish. In addition, the assembly of these modules is often difficult, particularly where the individual components are manufactured by more than one supplier.

A few of the problems of conventional designs are overcome through the use of molding processes by which a portion of the trim surrounding the window panel is fabricated by encapsulating the window periphery with a polymer using injection molding techniques. In essence, the window panel is placed in a mold cavity which is configured to produce a circumferential trim at the panel edges. The edges of the panel on which the injection molded trim will adhere are cleaned and primed to promote adhesion and to create a water-impervious seal in the formed article. The mold is then closed and the material is injected such that the window panel edges are encapsulated to form the desired trim geometry. From a quality standpoint, however, materials such as PVC and RIM used in prior art designs are somewhat undesirable when compared with the more resilient materials used for body sealing applications. Moreover, the use of plastics for encapsulation of the window pane and then the attachment thereto of a discrete rubber continuous strip trim using an interlocking channel or the like results in (1) an unwanted visual appearance caused by using two different polymeric materials and (2) the potential for water leakage and wind noise at the connection areas.

Thus, there is a need in the art for a fixed window/trim module which provides an encapsulated window pane where the trim is a resilient material, which provides the necessary continuous seal trim strip without the need to attach the strip as a discrete element and which joins the continuous seal trim sealing lip to the division post sealing lips to form continuous seals around the corner of the movable glass. The present invention provides a method and apparatus which meets this need.

### SUMMARY OF THE INVENTION

In one aspect, the present invention provides a method of manufacturing a fixed-pane motor vehicle window module. The module is constructed in a single injection molding operation in which the pane, division post, header extrusion, and continuous seal trim strip are used as inserts in a mold cavity. A portion of the division post and the majority of the header extrusion and continuous seal trim strip extends out of the mold. The window pane is received in a cavity in the mold and the division post, header and continuous strip are placed in their respective positions in the mold relative to the window pane. The mold is then closed and a polymer is injected into the mold cavity which forms an encapsulating trim around the window and a portion of the post. In addition, the injected polymer bonds with the end of the continuous seal trim strip in the mold to form an integral bond between the injection molded encapsulating trim and the continuous seal trim strip and the end of the division post trim. After the injected polymer has cured, the mold is opened and the window module is removed. The injected polymer is preferably EPDM.

Thus, in one aspect the method of the present invention includes the steps of providing a window pane, a division post, a header extrusion, a continuous seal trim strip and a mold having various cavities for receiving the window pane, a portion of the post and one end portion of the header and continuous trim strip; placing the window pane, the division post, header and the continuous seal in their respective portions in the mold cavity and placing any attachment brackets or the like in the mold; closing the mold; injecting a polymeric material into the mold to encapsulate a portion of window pane and a portion of the division post with the polymeric material and to integrally bond the end portions of the continuous seal trim strip, header and division post trim with the polymeric material; allowing the polymer to cure and form an encapsulated fixed window pane assembly having an integral continuous seal trim strip; and removing the encapsulated fixed window pane assembly having an integral continuous seal from the mold.

In another aspect the present invention provides a motor vehicle fixed window pane module having a motor vehicle window pane, a division post adjacent one edge of the window pane; and an encapsulating trim, encapsulating the circumferential edges of the window pane and a portion of the division post. The encapsulating trim is formed of a polymeric material and has an elongated continuous seal trim strip extending away from the post and the window, the continuous seal trim strip has a horizontal portion and a vertical portion, the vertical portion forming a B-pillar trim.

In still another aspect, the post is roll-formed and has a channel for receiving a movable window pane; the continuous seal trim strip and header are extrusion-formed and the encapsulating material, the continuous seal trim strip, header, and the division post trim are all formed of the same material.

### BRIEF DESCRIPTION OF THE DRAWINGS

FIG. 1 is a fragmentary, perspective view of the fixed window module of the present invention installed in a motor vehicle.

FIG. 2 is a back elevational view of the fixed window module of the present invention.

FIG. 3 is a fragmentary plan view of the open mold used in the present invention with the division post, window pane, continuous seal trim strip and header extrusion in position for molding.

FIG. 4 is a fragmentary front elevational view of a portion of the fixed window module of the present invention illustrating the integration of the continuous seal trim strip, header extrusion, the window pane and the post with the injected encapsulation portion of the trim.

FIG. 5 is a cross-sectional view along line 5-5 of FIG. 4.

FIG. 6 is a cross sectional view along line 6-6 of FIG. 2.

FIG. 7 is a cross sectional view along line 7-7 of FIG. 2.

### DETAILED DESCRIPTION OF THE PREFERRED EMBODIMENTS OF THE INVENTION

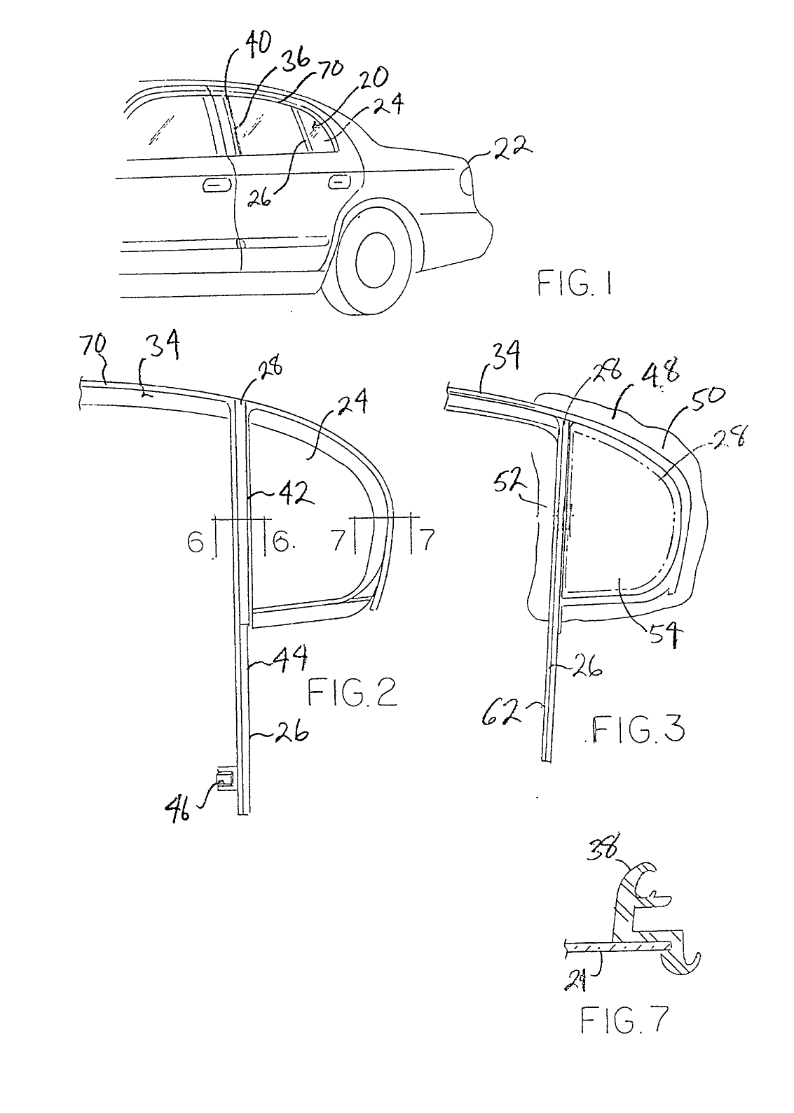

Referring now to FIGS. 1 and 2 of the drawings, the fixed panel assembly of the present invention is shown in one preferred embodiment as fixed window module 20 in motor vehicle 22. In FIG. 2, a rear door window module 20 is shown isolated from motor vehicle 22. Rear door window module 20 has window pane 24, division post 26 and header 70. Although a number of materials may be suitable in a particular application for window pane or panel 24, in most applications window pane 24 will comprise a conventional clear or tinted automotive glass pane, but may also be formed of plastic such as polycarbonate or other glazing type material.

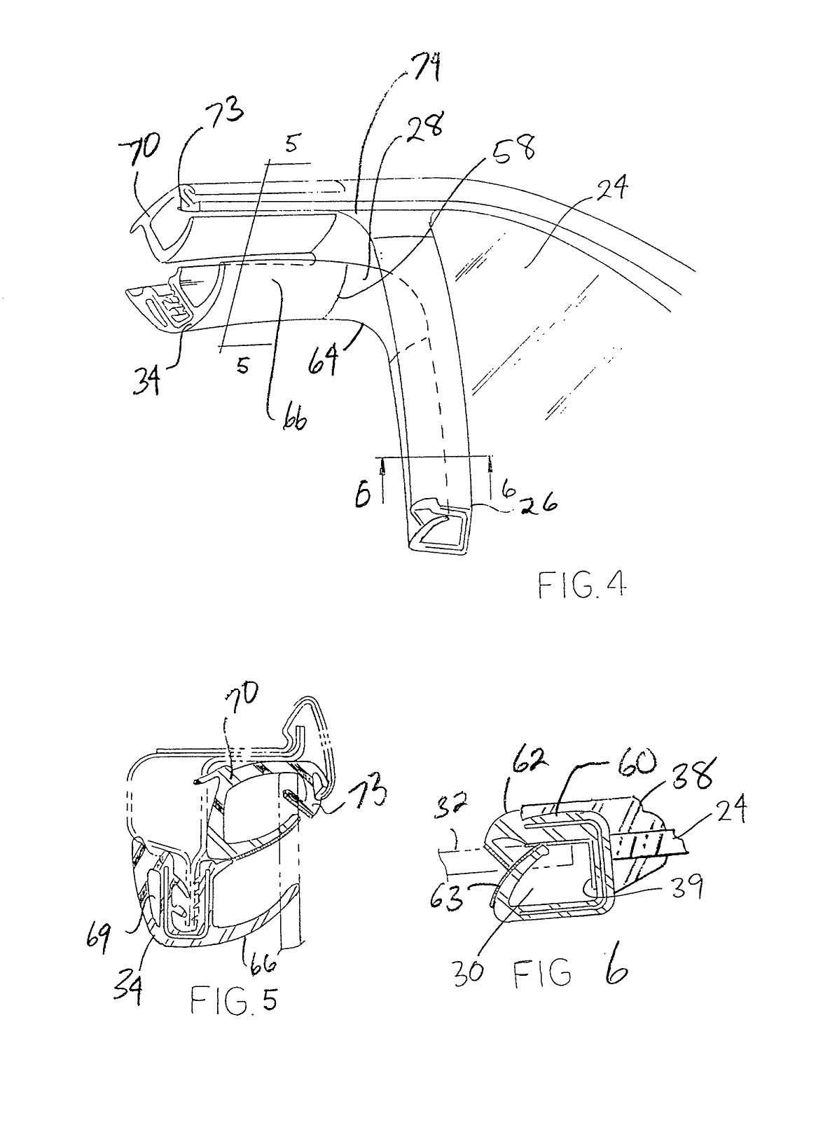

Referring additionally to FIGS. 4 and 6 of the drawings, division post 26 is generally rectangular in cross-section and most preferably comprises a roll-formed metal post which defines channel 30 for receiving a movable window pane (shown as window pane 32 in FIG. 1). Division post 26 is an EPDM co-extruded trim having an outside lip portion 62 and an inside lip portion 63 (shown in FIG. 6). As will be understood, D-post lip 62 forms a sealing surface on the outside surface of movable pane 32 along the rear edge of pane 32. As explained more fully hereinafter, inside D-post lip 63 seals the inside surface of movable pane 32. Division post 26 serves the conventional functions of support for pane 24, for separating movable window pane 32 from fixed pane 24 and for guiding movable window pane 32 via sliding contact in channel 30. Co-extruded trim 60 will preferably have a low-friction coating or flocked strip 39 associated therewith to permit the movable pane 32 to slide more easily.

As stated in the background of the invention, pre-molded trims into which glass panes are inserted are often undesirable, as is the mechanical fastening of extruded trim to encapsulated window modules. Accordingly, in the present invention, rear door window module 20 is provided having integrated trim 28 which is not only securely attached to window pane 24 by virtue of being molded thereon, but which also has fully integrated continuous seal 34, header 70, and B-pillar portions 36 (shown in FIG. 1) as will be fully described hereinafter. Accordingly, continuous extrusion or continuous trim strip 34 extends from encapsulation portion 38 of integrated trim 28. B-pillar extrusion or portion 36 is attached to header extrusion 70 at corner 40 (FIG. 1). In most applications, continuous trim strip 34 and B-pillar portion 36 will be extruded as two separate pieces which are bonded together at corner 40. In most applications of the present invention, header 70, continuous extrusion 34 and B-pillar portion 36 will be formed of ethylene propylene diene rubber (EPDM), styrene butadiene rubber (SBR), or other thermoset or thermoplastic polymers. Most preferred is EPDM. Various processing aids and other additives may be appropriate for use in combination with the preferred polymers. Most preferably, integrated trim 28 will be formed of the same preferred materials. As will be recognized by those skilled in the art, the length of continuous trim strip 34 will be dictated by the vehicle design, and can be as long as 85 inches.

Division post 26 in the completed rear window module has an encapsulated portion 42 and a non-encapsulated portion 44, the latter of which extends outside the mold cavity during fabrication. Mounting bracket 46 is provided, shown attached to division post 26 in the conventional manner. It is to be understood that additional mounting brackets and the like will ordinarily be present on rear window module 20 but could also apply to front doors. In addition, bracket 46 is shown as representative of all such mounting hardware.

Referring now to FIG. 2, an important aspect is the bonding of D-post trim lip 63 to continuous extrusion 34 at corner 64. That is, continuous lip 66 is joined by the molded polymer to D-post trim lip 63 to form a continuous radial trim region which fits securely around and against the corner of movable pane 32. This eliminates a serious flaw (inadequate seal) present in prior art designs. The injection molded material, therefore, fills in the space between continuous lip 66 and trim lip 63 to form the radial portion at corner 64. FIGS. 4 and 5 show a version of the present invention wherein a header seal extrusion 70 is also joined by encapsulation with the division post 26. It will be understood that the header seal extrusion 70 and D-post trim 60 have outside lips 62 and 73 for sealing movable window pane 32. The outside lips 62 and 73 are similarly joined at a radius (corner 74) by the injection molded polymer.

Referring now to FIG. 3 of the drawings, a fragment of mold 48 is shown having a mold space 50 which comprises several regions or spaces as will now be described. Mold space 48 is configured to receive window pane 24 (shown in phantom) a portion of division post 26 and an end portion of continuous trim strip 34. Accordingly, mold space 50 comprises division post receiving portion 52, window pane receiving space 54 and continuous extrusion receiving portion 56. That is, mold space 50 accommodates window pane 24, a portion of division post 26 and a portion of continuous trim strip 34 as inserts in the mold cavity. The geometry of these various insert regions or spaces in mold 48 will be a function of the geometry of the inserts. Mold 48 is provided with the appropriate seal region to retain the molded polymeric material within mold space 50.

In FIG. 3 of the drawings, a fragmentary portion of mold space 50 is shown in phantom to highlight the relative placement of window pane 24, division post 26 and end 58 of continuous trim strip 34. As will now be understood, a key feature of the present invention is providing a mold space 50 which accepts end 58 of continuous extrusion 34 so that once the EPDM is injected, the molded EPDM joins with EPDM continuous trim strip 34, header 70, and division post lip 63 and encapsulates window pane 24 to form a single unitary module 20. It is preferred that continuous trim strip 34 extend into mold space 50 from about 1 to about 3 inches. Mold slides are preferably used to facilitate injection and sealing of the inserts, particularly strips 34 and 70, and post 26 in the mold. The bonding of the molded portion of trim 28 to continuous trim strip 34 and division post lip 63 results in integral joints; it was discovered by the present inventors that the bonds appear to span the joints and are generally as strong as the trim at any point. The continuous seal extrusion 34 is bonded only to the division post 26 in the encapsulation mold. It is a separate seal from the header 70 and is not bonded to the header 70 at any point.

Various injection molding parameters such as the temperature of the polymer, injection and dwell times, the pressures, sprue design and gating are not unique to the present invention and appropriate values will be recognized by those skilled on the art based on the teachings provided by the present invention. For example, a cure (vulcanizing) temperature of from about 320° F. to about 450° F. is appropriate for use with EPDM. It is generally preferred to clean and prime the edges of pane 24 prior to molding.

In FIGS. 6 and 7, preferred profiles in one particular application of the present embodiment are shown. Accordingly, roll-formed post 26 is shown in FIG. 6 with co-extruded EPDM polymer 60. That is, as stated earlier, post 26 is most preferably formed and then co-extruded with EPDM rubber trim 60 prior to construction of module 20. Suitable polymers are EPDM, SBR, and other thermosets and thermoplastics. Most preferred is EPDM. In FIG. 6, the interfacial bond between co-extruded trim 60 and molded portion 38 is seen as is the relative position of window pane 24. Molded or encapsulated portion 38 provides tight positive retention of window pane 24. FIG. 7 illustrates the encapsulation of window pane 24 by the injected EPDM in a particular configuration of trim.

The continuous seal trim strip 34 has a tubular portion 69 (FIG. 5). A plug will be placed at an extreme end of the continuous seal trim strip 34 to prevent the injected polymer from filling this tubular portion. The plug can have a slight interference fit. The shape of the plug is dependent upon the shape of the tubular portion 69.

Thus, it is apparent that there has been provided in accordance with the invention a method and apparatus that fully satisfies the objects, aims and advantages set forth above. While the invention has been described in connection with specific embodiments thereof, it is evident that many alternatives, modifications, and variations will be apparent to those skilled in the art in light of the foregoing description. Accordingly, it is intended to embrace all such alternatives, modifications and variations that fall within the spirit and broad scope of the appended claims.

We claim:

1. A method of fabricating a fixed-pane motor vehicle window assembly, comprising the steps of:
providing a fixed window pane;
providing a division post having a channel adapted to receive a movable window pane;
providing a continuous seal trim strip adapted to contact an interior side of said movable window pane;
providing a mold having a mold cavity, said mold cavity having a space for receiving said window pane, a space for receiving said division post and a space for receiving an end portion of said continuous seal trim strip;
placing said window pane in said window pane-receiving space of said mold cavity;
placing said division post in said division post-receiving space of said mold cavity;
placing one end of said continuous seal trim strip into said continuous seal trim strip end portion-receiving space of said mold cavity;
closing said mold;
injecting a polymer into said mold to encapsulate a portion of said window pane and a portion of said division post with said polymer and to form a radial trim region integrally bonding said end portion of said continuous seal trim strip with said polymer, said radial trim region adapted to seal an interior portion of said movable window pane;
allowing said polymer to cure to form an encapsulated fixed window pane assembly having an integral continuous seal strip; and
removing said encapsulated fixed window pane assembly having an integral continuous seal trim strip from said mold.

2. The method of fabricating a fixed-pane motor vehicle window assembly recited in claim 1, wherein said division post has an associated co-extruded trim having at least one sealing lip and wherein said continuous seal trim strip has at least one sealing lip and wherein said polymer joins said sealing lip of said co-extruded trim and said sealing lip of said continuous seal by forming said radial trim region.

3. The method of fabricating a fixed-pane motor vehicle window assembly recited in claim 1, wherein said division post is roll-formed metal co-extruded with EPDM rubber.

4. The method of fabricating a fixed-pane motor vehicle window assembly recited in claim 1, wherein said window pane is selected from the group consisting of glass, plastic and other glazing materials.

5. The method of fabricating a fixed-pane motor vehicle window assembly recited in claim 2, wherein the edges of said window pane are primed prior to placing said window pane in said window pane receiving space.

6. The method of fabricating a fixed-pane motor vehicle window assembly recited in claim 1, wherein said continuous seal trim strip is extrusion-formed.

7. The method of fabricating a fixed-pane motor vehicle window assembly recited in claim 1, wherein said continuous seal trim strip has a length as long as 85 inches.

8. The method of fabricating a fixed-pane motor vehicle window assembly recited in claim 1, wherein said polymer is selected from the group consisting of EPDM, SBR and other thermoset and thermoplastic polymers and combinations thereof.

9. The method of fabricating a fixed-pane motor vehicle window assembly recited in claim 1, wherein said continuous seal trim strip is formed of the same material as said cured polymer.

10. The method of fabricating a fixed-pane motor vehicle window assembly recited in claim 8, wherein said division post is at least partially co-extruded with EPDM material prior to being placed in said post-receiving space of said mold cavity.

11. The method of fabricating a fixed-pane motor vehicle window assembly recited in claim 1, wherein said continuous seal trim strip has a tubular portion and a plug is placed into said tubular portion to prevent the injection of polymer into said tubular portion.

12. The method of fabricating a fixed-pane motor vehicle window assembly as recited in claim 1 0, wherein said plug has an interference fit within said tubular portion.

13. A method of fabricating a fixed-pane motor vehicle window assembly as recited in claim 1, wherein there is provided a header extrusion and said mold cavity has a space for receiving an end portion of said header extrusion and said end portion of said header extrusion is placed into said header extrusion end portion-receiving space of said mold cavity.

14. A method of making a fixed window module for a motor vehicle, comprising the steps of:
providing a glass window pane;
providing a post having a channel adapted to receive a movable window pane, said post having a resilient trim portion;
providing an extruded elongated continuous seal trim strip adapted to contact said movable win dow pane;
providing a mold having a mold cavity, said mold cavity having a space for receiving said glass window pane, a space for receiving said post and a space for receiving an end portion of said extruded elongated continuous seal trim strip;
placing said glass window pane in said window pane-receiving space of said mold cavity;
placing said post in said post-receiving space of said mold cavity such that one edge of said post contacts one edge of said glass window pane and such that a portion of said post extends out of said mold;
placing one end of said extruded elongated continuous seal trim strip into said continuous seal trim strip end portion-receiving space of said mold cavity such that a portion of said extruded continuous seal trim strip extends out of said mold;
closing said mold;
injecting a polymeric material into said mold to encapsulate a portion of said glass window pane and a portion of said post with said polymeric material and to form a radial trim region integrally linking said end portion of said extruded elongated continuous seal trim strip to said resilient trim portion of said post with said polymeric material, said radial trim region adapted to seal an interior portion of said movable window pane;
allowing said injected polymeric material to cure to form an injection molded trim which encapsulates the edges of said glass window pane, a portion of said post and said end of said extruded elongated continuous seal trim strip to form an encapsulated fixed window pane assembly having an integral continuous strip; and
removing said encapsulated fixed window pane assembly having an integral continuous strip from said mold.

15. The method of making a fixed window module for a motor vehicle recited in claim 14, wherein said post is roll-formed metal.

16. The method of making a fixed window module for a motor vehicle recited in claim 14, wherein the edges of said glass window pane are primed prior to placing said glass window pane in said window pane receiving space.

17. The method of making a fixed window module for a motor vehicle recited in claim 13, wherein said continuous seal trim strip has a length as long as 85 inches.

18. The method of making a fixed window module for a motor vehicle recited in claim 14, wherein said polymeric material is selected from the group consisting of EPDM, SBR and other thermosets and thermoplastics and combinations thereof.

19. The method of making a fixed window module for a motor vehicle recited in claim 18, wherein said continuous seal trim strip and said resilient trim of said post are formed of the same material as said polymeric material.

20. The method of making a fixed window module for a motor vehicle recited in claim 14, wherein said post is co-extruded with said resilient trim portion.

21. The method of fabricating a fixed-pane motor vehicle window assembly recited in claim 3, wherein said EPDM has an associated low friction coating region thereon.

22. The method of fabricating a fixed-pane motor vehicle window assembly as recited in claim 14, wherein there is provided a header extrusion and said mold cavity has a space for receiving an end portion of said header extrusion and said end portion of said header extrusion is placed into said header extrusion end portion-receiving space of said mold cavity.

23. The method of fabricating a fixed-pane motor vehicle window assembly as recited in claim 14, wherein said EPDM has an associated flocked region thereon.

24. A motor vehicle fixed window pane assembly, comprising:
a motor vehicle window pane;
a post adjacent one edge of said window pane; and
an encapsulating trim encapsulating the circumferential edges of said window pane and a portion of said post, said encapsulating trim being formed of a polymeric material and having a continuous seal trim strip extending away from said post.

25. The motor vehicle fixed window pane assembly as described in claim 23, further including a header extrusion extending away from and encapsulated with said encapsulating trim.
